(19) United States
(12) Patent Application Publication
(10) Pub. No.: US 2026/0149863 A1
(43) Pub. Date: May 28, 2026

(54) Electronic Device for a Camera Module, Method for Manufacturing the Same, and Camera Module

(71) Applicant: Pac Tech, Nauen (DE)

(72) Inventor: Matthias Fettke, Berlin (DE)

(21) Appl. No.: 19/197,565

(22) Filed: May 2, 2025

(30) Foreign Application Priority Data
Nov. 22, 2024 (DE) 10 2024 134 469.5

(51) Int. Cl. H04N 23/54; H04N 23/51

(52) U.S. Cl. CPC H04N 23/54; H04N 23/51

(57) ABSTRACT

The present disclosure relates to an electronic device for a camera module having a housing forming a light-incident opening, including: a substrate having a first side which is to be arranged in the housing to face the light-incident opening and a second side which is opposite to the first side and an image sensor which has a light-sensitive portion, is designed as a flip chip, and is mounted to the second side. The substrate is formed to be translucent at least in the area of the light-sensitive portion of the image sensor. The disclosure further relates to a camera module comprising the electronic device and a method for manufacturing the electronic device.

### BACKGROUND OF THE INVENTION

### Field of the Invention

The present disclosure relates to an electronic device for a camera module and a method for manufacturing the electronic device. The present disclosure further relates to a camera module comprising the electronic device.

### Description of Related Art

Almost all portable devices, like smartphones and tablets, are equipped with at least one camera module these days. Designers try to further reduce a thickness of portable devices. However, the potential for the reduction of the thickness inter alia depends on the dimensions of the camera module installed in the portable device.

### SUMMARY OF THE INVENTION

It is an object of the present disclosure to provide a technique that enables a reduction of dimensions of a camera module.

This object is solved by the electronic device, the method for manufacturing the electronic device, and the camera module according to the independent claims. Preferred embodiments are subject matter of the dependent claims.

An electronic device according to the present disclosure is to be used in a camera module having a housing forming a light-incident opening. The electronic device comprises a substrate (can also be referred to as an interposer) having a first side, which is to be arranged in the housing to face the light-incident opening, and a second side, which is opposite to the first side; and an image sensor, which has a light-sensitive portion, is designed as a flip chip, and is mounted to the second side. A flip chip is a die, which is to be connected with its contact points, e.g. contact pads, to contact points, e.g. contact pads, of another circuitry, i.e. the substrate, by means of contact material, e.g. solder. That is, in a mounted state, the contact points of the flip chip, i.e. the image sensor, are directed to the contact points of the substrate. The substrate is formed to be translucent at least in the area of the light-sensitive portion of the image sensor. Translucent means that at least a sufficient part of the light incident into the housing can pass through the substrate from the first side to the second side so that the image sensor can capture the incident light. The electronic device enables a reduction in thickness and avoids bonding the image sensor to the substrate by using wire bonds.

According to an aspect, the substrate can comprise an opening in the area of the light sensitive part of the image sensor. The substrate can be made of ceramic or organic material. Hence, the substrate can be formed easily.

According to an aspect, the substrate can comprise a step portion on the second side around the opening. The image sensor can be attached to the step portion. Hence, the thickness of the electronic device and, thus, the camera module can be even further reduced.

According to an aspect, a translucent element can cover the opening from the first side. Alternatively, the translucent element can be fitted into the opening. In this way, the opening can be covered and sealed. Further, the translucent element can have a light filtering property. Hence, the light incident in the housing can be filtered before being captured by the image sensor.

According to an alternative aspect, the substrate can be formed of translucent material. Hence, the substrate allows light to pass through it. In this way, it is not necessary to form the opening in the substrate.

According to an aspect, the translucent material can have a light filtering property. Hence, the light incident into the housing is filtered when passing through the substrate.

According to an aspect, the substrate can comprise a recess portion on the second side. The image sensor can be mounted in the recess portion. In this way, the thickness of the substrate formed of translucent material can be further reduced. In addition, the way of the light through the substrate is reduced.

According to an aspect, a sealing portion can be arranged between the substrate and the image sensor. The sealing portion can be formed around an entire circumference of the image sensor. The sealing portion can be formed around contact points between the substrate and the image sensor. The sealing portion can be made of solder or any other suitable sealing material, e.g. rubber or silicone. This aspect is preferably combined with the substrate formed of translucent material or the aspect having the translucent element. In this way, stray light and dust can be prevented from entering into the image sensor.

According to an aspect, the substrate can comprise through-holes in correspondence with contact points of the image sensor. The contact points can be formed by contact pads. The through-holes are filled with contact material. The contact material can be solder. In particular, the contact material is introduced into the through-holes by applying solder bodies. The solder bodies can be solder balls. More specifically, the solder bodies can be jetted into the through-holes. In this way, the image sensor designed as a flip chip can be mounted to the substrate without using a reflow oven.

A camera module according to the present disclosure comprises a housing forming a light-incident opening. At least one lens or a lens barrel supporting at least one lens can be mounted to the light-incident opening. The camera module further comprises an electronic device according to any one of the previous aspects, which is arranged in the housing. Since the electronic device enables a reduced thickness, a camera module with a reduced thickness can be achieved. In addition, the camera module can also achieve the effect of the above-described aspects.

A method for manufacturing an electronic device for a camera module having a housing forming a light-incident opening according to the present disclosure comprises the following steps: providing a substrate having a first side, which is to be arranged in the housing to face the light-incident opening, and a second side, which is opposite to the first side, providing an image sensor, which has a light-sensitive portion and is designed as a flip chip, and mounting the image sensor to the second side. The substrate is formed to be translucent at least in an area of a light-sensitive portion of the image sensor. The electronic device achieved by using the method enables a reduction in thickness and avoids bonding the image sensor to the substrate by using wire bonds.

According to an aspect, the substrate can comprise through-holes in correspondence with contact points, in particular contact pads, of the image sensor. The step of mounting the image sensor can then comprise a step of applying, in particular jetting, solder bodies, in particular solder balls, into the through-holes from the first side. In this way, the image sensor designed as a flip chip can be mounted to the substrate without using a reflow oven.

### BRIEF DESCRIPTION OF THE DRAWINGS

The present disclosure is described in the following with reference to the drawings. The same reference signs are assigned to the same or corresponding elements. In the drawings.

FIG. 1 schematically shows a cross-section view of a camera module comprising an electronic device according to one embodiment;

FIG. 2 schematically shows a cross-section view of an electronic device according to another embodiment;

FIG. 3 schematically shows a cross-section view of an electronic device according to a further embodiment;

FIG. 4 schematically shows a cross-section view of an electronic device according to yet another embodiment;

FIG. 5 schematically shows a cross-section view of an electronic device according to an additional embodiment;

FIG. 6 schematically shows a cross-section view of the electronic device along the dashed line shown in FIG. 5; and

FIG. 7 schematically shows a cross-section view of an electronic device according to yet a further embodiment.

The figures are merely schematic in nature and are intended solely for the purpose of understanding the disclosure. The proportions of the elements shown in the figures have been adjusted accordingly to make the disclosure easier to understand.

### DETAILED DESCRIPTION OF THE PREFERRED EMBODIMENTS

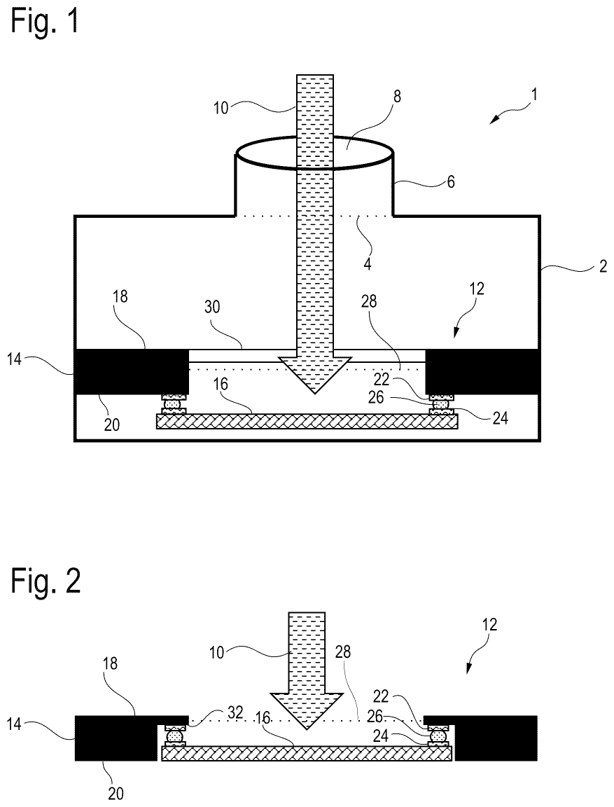

FIG. 1 schematically shows a cross-section view of a camera module 1 having a housing 2, which forms a light-incident opening 4. A lens barrel 6 supporting at least one lens 8 can be mounted to the light-incident opening 4. Light 10 can enter into the housing 2 through the lens 8 supported by the lens barrel 6, and, thus, through the light-incident opening 4.

An electronic device 12 according to one embodiment is arranged inside the housing 2. The electronic device 12 comprises a substrate 14 and an image sensor 16. The substrate 14 has a first side 18, which is arranged in the housing 2 to face the light-incident opening 4, and, thus, the lens barrel 6 supporting the lens 8. The substrate 14 also comprises a second side 20, which is opposite to the first side 18. That is, the second side 20 faces away from the light-incident opening 4. The image sensor 16 comprises a light-sensitive portion, which is a portion, in which photo diodes of the image sensor 16 are arranged. Further, the image sensor 16 is designed as a flip chip. A flip chip is a die, which is to be connected with its contact points to contact points of another circuitry, i.e. the substrate 14, by means of contact material, e.g. solder. That is, in a mounted state, the contact points of the image sensor 16 are directed to the contact points of the substrate 14.

As shown in FIG. 1, the image sensor 14 is mounted on the second side 20 of the substrate 14. The substrate 14 and the image sensor 16 comprise, as contact points, contact pads 22 and 24, which are arranged correspondingly. The contact pads 22 and 24 are joint by using contact material, for example solder 26. As can be understood from FIG. 1, the light-sensitive portion and the contact pads 24 are arranged on the same side of the image sensor 16.

In order to allow the light 10 entering the housing 2 to pass to the light-sensitive portion of the image sensor 16, the substrate 14 comprises an opening 28, which extends at least over the area of the light-sensitive portion of the image sensor 16.

As shown in FIG. 1, a translucent element 30 can be fitted into the opening 28. Alternatively, the translucent element 30 can be arranged on the first side 18 to cover the opening 28. The translucent element 30 can be made of glass. Additionally, the translucent element 30 can have a light filtering property.

The electronic device 12 allows a flat arrangement of the image sensor 16 on the substrate 18 so that the thickness of the overall camera module 1 can be reduced. Furthermore, wire bonding of an image sensor to a substrate can be avoided.

FIG. 2 schematically shows a cross-section view of an electronic device 12 according to another embodiment. The electronic device 12 of FIG. 2 is different to the electronic device 12 of FIG. 1 in that a step portion 32 is formed on the second side 20 around the opening 28. The contact pads 22 of the substrate 14 are positioned on the step portion 32 and are joint to the contact pads 24 of the image sensor 16 by using solder 26. In this way, an even flatter electronic device 12 and camera module 1 can be achieved. Although not shown in FIG. 2, the translucent element 30 can be fitted in the opening 28 or mounted on the first side 18.

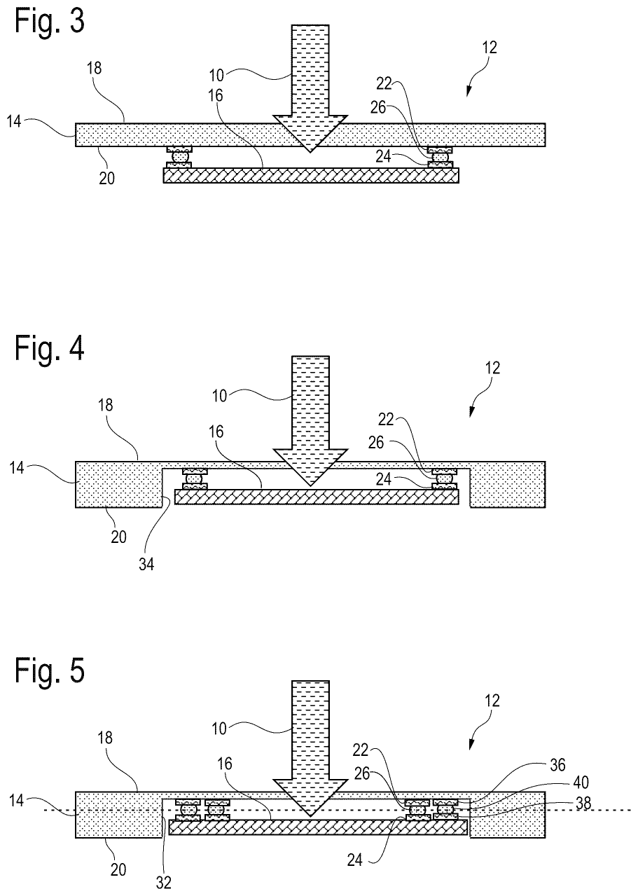

FIG. 3 schematically shows a cross-section view of an electronic device 12 according to a further embodiment. The electronic device 12 of FIG. 3 is different to the electronic device 12 of FIG. 1 in that the substrate 14 is formed of translucent material, e.g. glass. Hence, it is not necessary that the substrate 14 forms the opening 28. In addition, the translucent material can have a light filtering property. Hence, light 10 passing through the substrate is filtered before arriving at the image sensor 16.

FIG. 4 schematically shows a cross-section view of an electronic device 12 according to yet another embodiment. The electronic device 12 of FIG. 4 is different to the electronic device 12 of FIG. 3 in that a recess portion 34 is formed on the second side 20. The contact pads 22 of the substrate 14 are arranged in the recess portion 34 and are joint to the contact pads 24 of the image sensor 16 by using solder 26. In this way, an even flatter electronic device 12 and camera module 1 can be achieved.

FIG. 5 schematically shows a cross-section view of an electronic device 12 according to an additional embodiment. The electronic device 12 of FIG. 5 is different to the electronic device 12 of FIG. 4 in that a sealing portion 40 is arranged between the substrate 14 and the image sensor 16. The sealing portion 40 is formed around the contact points, i.e. the contact pads 22, 24, and the solder 26. The sealing portion 40 can be made of solder and formed on contact stripes 36 and 38, which are formed around an entire circumference of the image sensor 16.

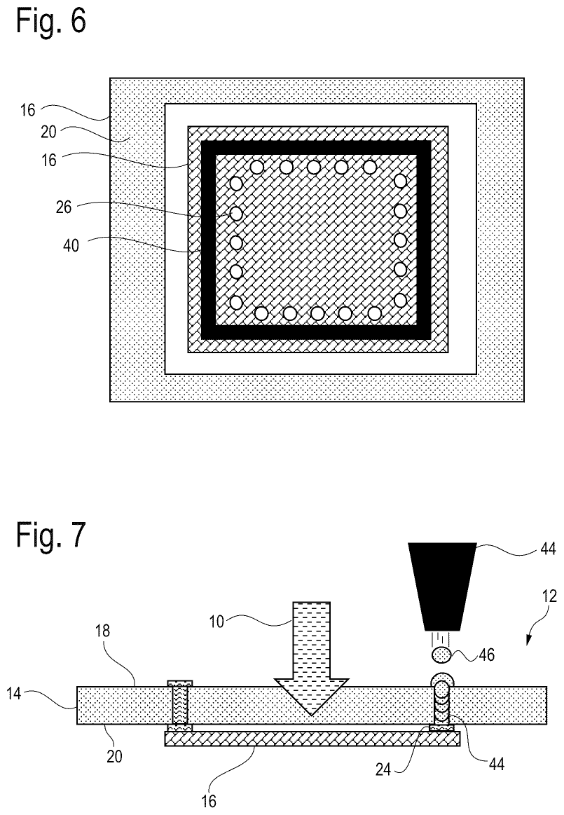

FIG. 6 schematically shows a cross-section view of the electronic device 12 along the dashed line shown in FIG. 5. As can be seen in FIG. 6, the sealing portion 40 and, thus, the contact stripes 36, 38 are formed around an entire circumference of the image sensor 16. By forming the sealing portion 40, stray light and dust can be prevented from entering into the light-sensitive portion of the image sensor 16. Since the light-sensitive portion of the image sensor 16 faces the substrate 14 formed of translucent material, the image sensor 16 is hermetically sealed. Nevertheless, the contact stripes 36, 38 and the sealing portion 40 can also be formed in the electronic devices shown in FIGS. 1 to 3. Hermetic sealing can also be achieved in combination with the embodiment having the translucent element 30, as for example shown in FIG. 1.

FIG. 7 schematically shows a cross-section view of an electronic device 12 according to yet a further embodiment. The electronic device 12 of FIG. 7 is different to the electronic device 12 of FIG. 3 in that the substrate 14 forms through holes 44 in the area of contact points, i.e. the contact pads 24, of the image sensor 16. The contact pads 24 are then contacted to leads on the first side 18 of the substrate 14 in that the through-holes 44 are filled with contact material, in particular solder. More specifically, the through-holes 44 can be filled by applying solder bodies into the through-holes 44. For example, a jetting tool 44 can be used to jet solder balls 46 as an example of the solder bodies into the through-holes 44. In this way, the image sensor 16 can be mounted to the substrate 14 without the need of using a reflow oven. The through-holes 44 formed in the substrate 14 and filled with solder can be combined with the embodiments of the electronic device 12 shown in FIGS. 1, 2, 4 and 5.

Although the best mode contemplated by the inventors of carrying out the present invention is disclosed above, practice of the above invention is not limited thereto. It will be manifest that various additions, modifications and rearrangements of the features of the present invention may be made without deviating from the spirit and the scope of the underlying inventive concept.

1. An electronic device for a camera module having a housing forming a light-incident opening, comprising:
a substrate having a first side (which is to be arranged in the housing to face the light-incident opening, and a second side, which is opposite to the first side; and
an image sensor, which has a light-sensitive portion, is designed as a flip chip, and is mounted to the second side and,
wherein the substrate is formed to be translucent at least in the area of the light-sensitive portion of the image sensor.

2. The electronic device according to claim 1, wherein,
the substrate comprises an opening in the area of the light sensitive part of the image sensor.

3. The electronic device according to claim 2, wherein
the substrate comprises a step portion on the second side around the opening, and
the image sensor is attached to the step portion,

4. The electronic device according to claim 2, further comprising
a translucent element, which covers the opening from the first side or is fitted into the opening.

5. The electronic device according to claim 1, wherein the substrate is formed of a translucent material.

6. The electronic device according to claim 5, wherein the translucent material has a light filtering property.

7. The electronic device according to claims 5, wherein the substrate comprises a recess portion on the second side and the image sensor is mounted in the recess portion.

8. The electronic device according to claim 1 further comprising:
a sealing portion arranged between the substrate and the image sensor and formed around entire circumference of the image sensor.

9. The electronic device according to any claim 1 wherein
the substrate comprises through-holes in correspondence with contact points of the image sensor, and
the through-holes are filled with contact material.

10. A camera module, comprising:
a housing forming a light-incident opening; and
an electronic device according to claim 1 arranged in the housing.

11. A method for manufacturing an electronic device for a camera module having a housing forming a light-incident opening, comprising the steps of:
providing a substrate having a first side, which is to be arranged in the housing to face the light-incident opening, and a second side, which is opposite to the first side,
providing an image sensor, which has a light-sensitive portion and is designed as a flip chip,
mounting the image sensor to the second side;
wherein the substrate is formed to be translucent at least and in an area of a light-sensitive portion of the image sensor

12. The method according to claim 11, wherein
the substrate comprises through-holes in correspondence with contact points of the image sensor, and
the step of mounting the image sensor comprises a step of applying solder into the through-holes from the first side.
